(19) United States
(12) Patent Application Publication
(10) Pub. No.: US 2024/0326339 A1
(43) Pub. Date: Oct. 3, 2024

(54) INTEGRATION OF 3D PRINTED ASSISTANCE COMPONENTS WITH E-COMMERCE PURCHASES

(71) Applicant: International Business Machines Corporation, Armonk, NY (US)

(72) Inventors: Zachary A. Silverstein, Georgetown, TX (US); Logan Bailey, Atlanta, GA (US); Mauro Marzorati, Lutz, FL (US); Suman Patra, Kolkata (IN)

(21) Appl. No.: 18/193,670

(22) Filed: Mar. 31, 2023

(51) Int. Cl. B29C 64/393; B33Y 50/02; G06Q 30/012; G06Q 30/0203; G06Q 30/0601

(52) U.S. Cl. CPC B29C 64/393; B33Y 50/02; G06Q 30/012; G06Q 30/0203; G06Q 30/0621; G06Q 30/0631

(57) ABSTRACT

In an approach for automatically printing a three-dimensional object to assist in a repair or replacement of a currently owned product, a processor identifies one or more components of the currently owned product to be repaired or replaced with a new product in response to determining that a user has purchased the new product that the user intends to use to replace or repair the currently owned product with based on a purchase history of the user. A processor retrieves a 3D printing file associated with the one or more components. A processor automatically 3D prints the one or more components using the 3D printing file.

### BACKGROUND OF THE INVENTION

The present invention relates generally to the field of data processing, and more particularly to a system and method to integrate three-dimensional (3D) printed assistance components with e-commerce purchases.

3D printing is transforming our world, helping to drive ground-breaking advances in industries such as healthcare, electronics, and aerospace. These advanced technologies are enabling major scientific discoveries and revolutionizing manufacturing processes. The 3D printing industry itself is also undergoing a transformation, as it shifts to additive manufacturing, using this technology for real products, and not just prototypes. The 3D printing industry is now used to create everything from prosthetic limbs for humans and animals, to futuristic concept cars, soft robotics for navigating hazardous environments during rescue operations, and miniature satellites for the European Space Agency.

Additive manufacturing is the industrial production name for 3D printing. Additive manufacturing is a computer-controlled process that creates 3D objects by depositing materials, usually in layers. Using computer aided design or 3D object scanners, additive manufacturing allows for the creation of objects with precise geometric shapes. These are built layer by layer, as with a 3D printing process, which is in contrast to traditional manufacturing that often requires machining or other techniques to remove surplus material.

Propelled by the unprecedented circumstances of the COVID-19 pandemic, many businesses have turned to e-commerce to stay financially viable, increasing final consumers' purchasing via online platforms. E-commerce is the buying and selling of goods and services on the internet. Additive manufacturing can provide significant benefits to e-commerce in several ways: it speeds up production, reduces costs and inventory waste, and allows for custom-made and highly personalized product design, etc.

### SUMMARY

Aspects of an embodiment of the present invention disclose a method, computer program product, and computer system for automatically printing a three-dimensional object to assist in a repair or replacement of a currently owned product. Responsive to determining that a user has purchased a new product that the user intends to use to replace or repair a currently owned product with based on a purchase history of the user, a processor identifies one or more components of the currently owned product to be repaired or replaced with the new product. A processor retrieves a 3D printing file associated with the one or more components. A processor automatically 3D prints the one or more components using the 3D printing file.

In some aspects of an embodiment of the present invention, prior to determining that the user has purchased the new product that the user intends to use to replace or repair the currently owned product with based on the purchase history of the user, a processor gathers a prior purchase history of the user on an e-commerce platform. A processor captures a search history and a previously viewed history of the user on the e-commerce platform. A processor extracts a word, a topic, or a family of products associated with the word or the topic from the search history and the previously viewed history of the user on the e-commerce platform.

In some aspects of an embodiment of the present invention, subsequent to extracting the word, the topic, or the family of products associated with the word or the topic extracted from the search history and the previously viewed history of the user on the e-commerce platform, a processor queries a mapping table to view the currently owned product to be repaired or replaced with the new product, wherein the mapping table is comprised of a first side associated with one or more product tags and one or more known associations and a second side associated with a reference to the 3D printing file.

In some aspects of an embodiment of the present invention, the one or more components of the currently owned product to be repaired or replaced with the new product are identified based on a first indication of a malfunctioning component of the currently owned product or based on a second indication of a need for improvement to the currently owned product.

In some aspects of an embodiment of the present invention, the 3D printing file is specific to the currently owned product to be repaired or replaced with the new product.

In some aspects of an embodiment of the present invention, the one or more components 3D printed meet one or more usability parameters, and wherein the one or more usability parameters are one or more of an expected lifetime, one or more operating characteristics, and one or more cost constraints.

In some aspects of an embodiment of the present invention, a processor compensates the user for preparing a three-dimensional print of the currently owned product to be repaired or replaced with the new product.

In some aspects of an embodiment of the present invention, subsequent to automatically 3D printing the one or more components using the 3D printing file, a processor outputs a request for feedback to the user. A processor receives a set of feedback input by the user. A processor processes the set of feedback input by the user. A processor incorporates the set of feedback into how a component of the currently owned product to repaired or replaced with the new product is identified.

These and other features and advantages of the present invention will be described in, or will become apparent to those of ordinary skill in the art in view of, the following detailed description of the example embodiments of the present invention.

### BRIEF DESCRIPTION OF THE DRAWINGS

FIG. 1 is a functional block diagram illustrating a distributed data processing environment, in accordance with an embodiment of the present invention;

FIG. 2 is a flowchart illustrating the operational steps of an automatic three-dimensional printing program, on a server within the distributed data processing environment of FIG. 1, in accordance with an embodiment of the present invention; and

FIG. 3 depicts a block diagram of components of a computing environment representing the distributed data processing environment of FIG. 1, in accordance with an embodiment of the present invention.

### DETAILED DESCRIPTION

Embodiments of the present invention recognize that e-commerce, the buying and selling of goods and services on the internet, drives a number of ad-hoc purchases. An ad-hoc purchase is the purchase of a good on an as-needed basis. An ad-hoc purchase occurs when a consumer buys a good outside of the consumer's normal purchasing cycle or when the consumer needs a good in a hurry. For example, an ad-hoc purchase occurs when a consumer purchases a good that is similar but newer than a good the consumer currently possesses after seeing an advertisement for the similar but newer good on the internet. Embodiments of the present invention recognize that replacing a good the consumer currently possesses with the same good or a similar good may require some effort on the part of the consumer. For example, replacing a lightbulb requires minimal effort on the part of the consumer. In this case, the consumer need only purchase a new lightbulb of the same type, the same wattage, and the same features. Replacing a control box for a sprinkler system, however, requires more than minimal effort on the part of the consumer. Therefore, embodiments of the present invention recognize the need for a system and method to assist in the repair or replacement of a good bought by the consumer on the internet via e-commerce. Embodiments of the present invention provide a system and method to automatically print a three-dimensional object to assist in a repair or replacement of a good (hereinafter referred to as a “product”).

Implementation of embodiments of the present invention may take a variety of forms, and exemplary implementation details are discussed subsequently with reference to the Figures.

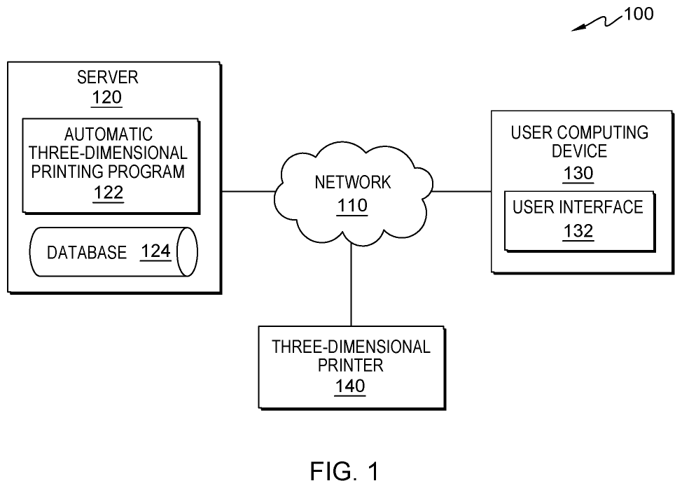

FIG. 1 is a block diagram illustrating a distributed data processing environment, generally designated 100, in accordance with an embodiment of the present invention. In the depicted embodiment, distributed data processing environment 100 includes server 120, user computing device 130, and three-dimensional printer 140, interconnected over network 110. Distributed data processing environment 100 may include additional servers, computers, computing devices, and other devices not shown. The term “distributed” as used herein describes a computer system that includes multiple, physically distinct devices that operate together as a single computer system. FIG. 1 provides only an illustration of one embodiment of the present invention and does not imply any limitations with regards to the environments in which different embodiments may be implemented. Many modifications to the depicted environment may be made by those skilled in the art without departing from the scope of the invention as recited by the claims.

Network 110 operates as a computing network that can be, for example, a telecommunications network, a local area network (LAN), a wide area network (WAN), such as the Internet, or a combination of the three, and can include wired, wireless, or fiber optic connections. Network 110 can include one or more wired and/or wireless networks capable of receiving and transmitting data, voice, and/or video signals, including multimedia signals that include data, voice, and video information. In general, network 110 can be any combination of connections and protocols that will support communications between server 120, user computing device 130, three-dimensional printer 140, and other computing devices (not shown) within distributed data processing environment 100.

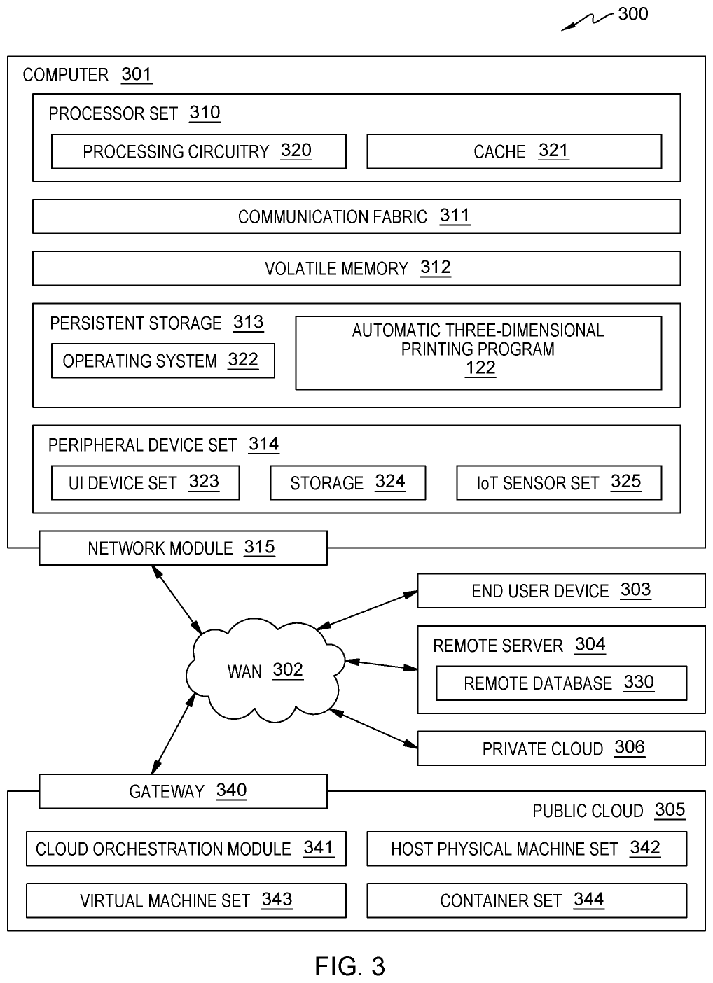

Server 120 operates to run automatic three-dimensional printing program 122 and to send and/or store data in database 124. In an embodiment, server 120 can send data from database 124 to user computing device 130 and three-dimensional printer 140. In an embodiment, server 120 can receive data in database 124 from user computing device 130 and three-dimensional printer 140. In one or more embodiments, server 120 can be a standalone computing device, a management server, a web server, a mobile computing device, or any other electronic device or computing system capable of receiving, sending, and processing data and capable of communicating with user computing device 130 and three-dimensional printer 140 via network 110. In one or more embodiments, server 120 can be a computing system utilizing clustered computers and components (e.g., database server computers, application server computers, etc.) that act as a single pool of seamless resources when accessed within distributed data processing environment 100, such as in a cloud computing environment. In one or more embodiments, server 120 can be a laptop computer, a tablet computer, a netbook computer, a personal computer, a desktop computer, a personal digital assistant, a smart phone, or any programmable electronic device capable of communicating with user computing device 130, three-dimensional printer 140, and other computing devices (not shown) and three-dimensional printers (not shown) within distributed data processing environment 100 via network 110. Server 120 may include internal and external hardware components, as depicted and described in further detail in FIG. 3.

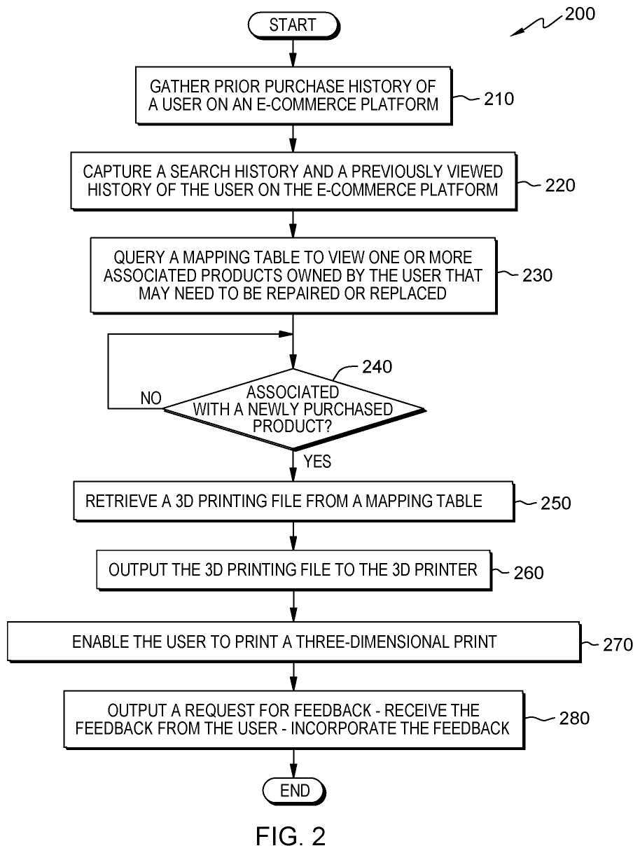

Automatic three-dimensional printing program 122 operates to automatically print a three-dimensional object to assist in a repair or replacement of a product. In the depicted embodiment, automatic three-dimensional printing program 122 is a standalone program. In another embodiment, automatic three-dimensional printing program 122 may be integrated into another software product. In the depicted embodiment, automatic three-dimensional printing program 122 resides on server 120. In another embodiment, automatic three-dimensional printing program 122 may reside on another computing device (not shown), provided that automatic three-dimensional printing program 122 has access to network 110. The operational steps of automatic three-dimensional printing program 122 are depicted and described in further detail with respect to FIG. 2.

In an embodiment, the user of user computing device 130 registers with automatic three-dimensional printing program 122 of server 120. For example, the user completes a registration process (e.g., user validation), provides information to create a user profile, and authorizes the collection, analysis, and distribution (i.e., opts-in) of relevant data on identified computing devices (e.g., on user computing device 130) by server 120 (e.g., via automatic three-dimensional printing program 122). Relevant data includes, but is not limited to, personal information or data provided by the user or inadvertently provided by the user's device without the user's knowledge; time stamped temporal information (e.g., to infer contextual reference points); and specifications pertaining to the software or hardware of the user's device. In an embodiment, the user opts-in or opts-out of certain categories of data collection. For example, the user can opt-in to provide all requested information, a subset of requested information, or no information. In one example scenario, the user opts-in to provide time-based information, but opts-out of providing location-based information (on all or a subset of computing devices associated with the user). In an embodiment, the user opts-in or opts-out of certain categories of data analysis. In an embodiment, the user opts-in or opts-out of certain categories of data distribution. Such preferences can be stored in database 124.

Database 124 operates as a repository for data received, used, and/or generated by automatic three-dimensional printing program 122. A database is an organized collection of data. Data includes, but is not limited to, information about user preferences (e.g., general user system settings such as alert notifications for user computing device 130); information about alert notification preferences; a prior purchase history of a user on an e-commerce platform; a search history of the user on an e-commerce platform; a previously viewed history of the user on an e-commerce platform; any words, any topics, and any family of products associated with the words and the topics searched for from the search history; an STL file (a typical file format for 3D printing) or another type of 3D printing file associated with one or more components needed to repair or replace a candidate product with a new product; and any other data received, used, and/or generated by automatic three-dimensional printing program 122.

Database 124 can be implemented with any type of device capable of storing data and configuration files that can be accessed and utilized by server 120, such as a hard disk drive, a database server, or a flash memory. In an embodiment, database 124 is accessed by automatic three-dimensional printing program 122 to store and/or to access the data. In the depicted embodiment, database 124 resides on server 120. In another embodiment, database 124 may reside on another computing device, server, cloud server, or spread across multiple devices elsewhere (not shown) within distributed data processing environment 100, provided that automatic three-dimensional printing program 122 has access to database 124.

The present invention may contain various accessible data sources, such as database 124, that may include personal and/or confidential company data, content, or information the user wishes not to be processed. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal and/or confidential company data. Automatic three-dimensional printing program 122 enables the authorized and secure processing of personal data.

Automatic three-dimensional printing program 122 provides informed consent, with notice of the collection of personal and/or confidential data, allowing the user to opt-in or opt-out of processing personal and/or confidential data. Consent can take several forms. Opt-in consent can impose on the user to take an affirmative action before personal and/or confidential data is processed. Alternatively, opt-out consent can impose on the user to take an affirmative action to prevent the processing of personal and/or confidential data before personal and/or confidential data is processed. Automatic three-dimensional printing program 122 provides information regarding personal and/or confidential data and the nature (e.g., type, scope, purpose, duration, etc.) of the processing. Automatic three-dimensional printing program 122 provides the user with copies of stored personal and/or confidential company data. Automatic three-dimensional printing program 122 allows the correction or completion of incorrect or incomplete personal and/or confidential data. Automatic three-dimensional printing program 122 allows for the immediate deletion of personal and/or confidential data.

User computing device 130 operates to run user interface 132 through which a user can interact with automatic three-dimensional printing program 122 on server 120. In an embodiment, user computing device 130 is a device that performs programmable instructions. For example, user computing device 130 may be an electronic device, such as a laptop computer, a tablet computer, a netbook computer, a personal computer, a desktop computer, a smart phone, or any programmable electronic device capable of running the respective user interface 132 and of communicating (i.e., sending and receiving data) with automatic three-dimensional printing program 122 via network 110. In general, user computing device 130 represents any programmable electronic device or a combination of programmable electronic devices capable of executing machine readable program instructions and communicating with other computing devices (not shown) within distributed data processing environment 100 via network 110. In the depicted embodiment, user computing device 130 includes an instance of user interface 132.

User interface 132 operates as a local user interface between automatic three-dimensional printing program 122 on server 120 and a user of user computing device 130. In some embodiments, user interface 132 is a graphical user interface (GUI), a web user interface (WUI), and/or a voice user interface (VUI) that can display (i.e., visually) or present (i.e., audibly) text, documents, web browser windows, user options, application interfaces, and instructions for operations sent from automatic three-dimensional printing program 122 to a user via network 110. User interface 132 can also display or present alerts including information (such as graphics, text, and/or sound) sent from automatic three-dimensional printing program 122 to a user via network 110. In an embodiment, user interface 132 can send and receive data (i.e., to and from automatic three-dimensional printing program 122 via network 110, respectively). Through user interface 132, a user can opt-in to automatic three-dimensional printing program 122; input information about the user; create a user profile; set user preferences and alert notification preferences; search an e-commerce platform; view an e-commerce platform; purchase a product on an e-commerce platform; receive an STL file or a 3D printing file; initiate the printing of one or more components of a currently owned product needed to be repaired or replaced with a new product using a STL file or a 3D printing file; receive compensation for preparing a three-dimensional print of the one or more components of a currently owned product needed to be repaired or replaced or for a blueprint of the one or more components of a currently owned product needed to be repaired or replaced; receive a request for feedback; and input feedback.

A user preference is a setting that can be customized for a particular user. A set of default user preferences are assigned to each user of automatic three-dimensional printing program 122. A user preference editor can be used to update values to change the default user preferences. User preferences that can be customized include, but are not limited to, general user system settings, specific user profile settings, alert notification settings, and machine-learned data collection/storage settings. Machine-learned data is a user's personalized corpus of data. Machine-learned data includes, but is not limited to, past results of iterations of automatic three-dimensional printing program 122.

Three-dimensional printer 140 operates to automatically print a three-dimensional object as instructed by automatic three-dimensional printing program 122. In an embodiment, three-dimensional printer 140 can receive data from server 120, database 124, and/or user computing device 130. In an embodiment, three-dimensional printer 140 can send data to server 120, database 124, and/or user computing device 130. In the depicted embodiment, three-dimensional printer 140 is a standalone device.

FIG. 2 is a flowchart, generally designated 200, illustrating the operational steps for automatic three-dimensional printing program 122, on server 120 within distributed data processing environment 100 of FIG. 1, in accordance with an embodiment of the present invention. In an embodiment, automatic three-dimensional printing program 122 operates to automatically print a three-dimensional object to assist in a repair or replacement of a currently owned product. It should be appreciated that the process depicted in FIG. 2 illustrates one possible iteration of the process flow, which may be repeated each time a currently owned product needs to be repaired or replaced.

In step 210, automatic three-dimensional printing program 122 gathers a prior purchase history of a user. In an embodiment, automatic three-dimensional printing program 122 gathers a prior purchase history of a user on an e-commerce platform. In an embodiment, automatic three-dimensional printing program 122 gathers a prior purchase history of a user from an e-commerce platform. In another embodiment, automatic three-dimensional printing program 122 gathers a prior purchase history of a user from an IoT feed.

In step 220, automatic three-dimensional printing program 122 captures a search history of the user on the e-commerce platform. In an embodiment, automatic three-dimensional printing program 122 captures a previously viewed history of the user on the e-commerce platform. In an embodiment, automatic three-dimensional printing program 122 extracts any words searched for from the search history of the user on the e-commerce platform. In an embodiment, automatic three-dimensional printing program 122 extracts any topics searched for from the search history of the user on the e-commerce platform. In an embodiment, automatic three-dimensional printing program 122 extracts any family of products associated with the words extracted. In an embodiment, automatic three-dimensional printing program 122 extracts any family of products associated with the topics extracted.

In step 230, automatic three-dimensional printing program 122 queries a mapping table. In an embodiment, automatic three-dimensional printing program 122 queries a mapping table created from the prior purchase history of the user. In an embodiment, automatic three-dimensional printing program 122 queries a mapping table to view a product currently owned by the user that may need to be repaired or replaced (i.e., a candidate product for repair or replacement, hereinafter referred to as a “candidate product”). In another embodiment, automatic three-dimensional printing program 122 queries a tag table. In an embodiment, automatic three-dimensional printing program 122 queries a tag table created from the prior purchase history of the user. In an embodiment, automatic three-dimensional printing program 122 queries a tag table to view a candidate product. A first side of the mapping table is associated with one or more product tags and one or more known associations. A second side of the mapping table is associated with a STL file (a typical file format for 3D printing) or another type of 3D printing file. STL is an acronym for stereolithography, a three-dimensional printing technology. STL is a file format used in three-dimensional printing and computer-aided design.

In decision step 240, automatic three-dimensional printing program 122 determines whether the user has purchased a new product with which the user intends to use to replace or repair a candidate product based on the prior purchase history of the user. If automatic three-dimensional printing program 122 determines the user has purchased a new product with which the user intends to use to replace or repair a candidate product (decision step 240, YES branch), then automatic three-dimensional printing program 122 proceeds to step 250, retrieving an STL file or another type of 3D printing file. If automatic three-dimensional printing program 122 determines the user has not purchased a new product with which the user intends to use to replace or repair a candidate product (decision step 240, NO branch), then automatic three-dimensional printing program 122 continues to monitor for a candidate product associated with a newly purchased product.

In step 250, responsive to determining that the user has purchased a new product that the user intends to use to replace or repair a candidate product, automatic three-dimensional printing program 122 identifies one or more components of the candidate product to be repaired or replaced with the new product. In an embodiment, automatic three-dimensional printing program 122 identifies one or more components of the candidate product to be repaired or replaced with the new product based on a first indication of a malfunctioning component of the candidate product. In an embodiment, automatic three-dimensional printing program 122 identifies one or more components of the candidate product to be repaired or replaced with the new product based on a second indication of a need for improvement to the candidate product. In an embodiment, automatic three-dimensional printing program 122 retrieves an STL file or another type of 3D printing file associated with the one or more components of the candidate product needed to be repaired or replaced with the new product from the mapping table. In some embodiments, the STL file or another type of 3D printing file is specific to the candidate product that needs to be repaired or replaced. In some embodiments, the STL file or another type of 3D printing file is based on a set of data captured from one or more additional users in the household of the user (e.g., such as a preferred printer and/or a preferred material). In some embodiments, the STL file or another type of 3D printing file is generic.

For example, user B purchases a new sprinkler control box. Automatic three-dimensional printing program 122 recognizes the purchase of the new sprinkler control box and identifies one or more additional components needed to repair or replace an old sprinkler control box with the new sprinkler control box. Automatic three-dimensional printing program 122 identifies an additional component needed as a harness for the wires of user B's previous sprinkler control box. Automatic three-dimensional printing program 122 retrieves a 3D printing file specifically based on the model of user B's previous sprinkler control box.

In step 260, automatic three-dimensional printing program 122 outputs the STL file or the 3D printing file to a three-dimensional printer (e.g., three-dimensional printer 140) of the user. In an embodiment, the three-dimensional printer (e.g., three-dimensional printer 140) of the user receives the STL file or the 3D printing file based on a timed delivery. In another embodiment, the three-dimensional printer receives the STL file or the 3D printing file based on a pre-emptive shipping manner. In an embodiment, the three-dimensional printer (e.g., three-dimensional printer 140) of the user receives the STL file or the 3D printing file by downloading the STL file or the 3D printing file from a subscribed location.

In step 270, automatic three-dimensional printing program 122 prints the one or more components of the candidate product needed to be repaired or replaced with the new product using the STL file or the 3D printing file automatically. In another embodiment, automatic three-dimensional printing program 122 enables the user to initiate the printing of the one or more components of the candidate product needed to be repaired or replaced with the new product using the STL file or the 3D printing file. The three-dimensional printer (e.g., three-dimensional printer 140) of the user may, but is not required to, meet one or more usability parameters. The one or more usability parameters may include, but are not limited to, an expected lifetime, one or more operating characteristics, and one or more cost constraints.

For example, user B purchases a new sprinkler control box. Automatic three-dimensional printing program 122 identifies one or more components needed to produce a harness for the wires of sprinkler control box currently owned by user B. Automatic three-dimensional printing program 122 retrieves a 3D printing file associated with the model of the sprinkler control box currently owned by user B to print the harness for the wires.

In an embodiment, automatic three-dimensional printing program 122 may compensate the user for preparing a three-dimensional print of the one or more components of the candidate product to be repaired or replaced with the new product. In an embodiment, automatic three-dimensional printing program 122 may compensate the user for a blueprint of the one or more components of the candidate product to be repaired or replaced with the new product. For example, user C is looking to purchase a new control system. E-commerce platform D provides a coupon to be used when purchasing the three-dimensional print of the control system.

In step 280, automatic three-dimensional printing program 122 outputs a request for feedback to the user. In an embodiment, automatic three-dimensional printing program 122 outputs a request for feedback to the user via a user computing device (e.g., user computing device 130). In an embodiment, automatic three-dimensional printing program 122 enables the user to input feedback via a user interface (e.g., user interface 132) of a user computing device (e.g., user computing device 130). In an embodiment, automatic three-dimensional printing program 122 receives the feedback input by the user. In an embodiment, automatic three-dimensional printing program 122 processes the feedback input by the user. In an embodiment, automatic three-dimensional printing program 122 incorporates the feedback regarding how a component of the candidate product to be repaired or replaced is identified. In an embodiment, automatic three-dimensional printing program 122 incorporates any additional recommendations made by any products associated with automatic three-dimensional printing program 122 and/or the user.

For example, automatic three-dimensional printing program 122 receives feedback suggesting a shim be added to the sprinkler control box in order to make the sprinkler control box sit up straight. Automatic three-dimensional printing program 122 produces the shim and incorporates the shim into the sprinkler control box. In an embodiment, automatic three-dimensional printing program 122 stores the feedback input by the user in a database (e.g., database 124).

FIG. 3 depicts a block diagram of components of server 120 within distributed data processing environment 100 of FIG. 1, in accordance with an embodiment of the present invention. It should be appreciated that FIG. 3 provides only an illustration of one implementation and does not imply any limitations with regard to the environments in which different embodiments can be implemented. Many modifications to the depicted environment can be made.

Computing environment 300 contains an example of an environment for the execution of at least some of the computer code involved in performing the inventive methods, such as automatic three-dimensional printing program 122. In addition to automatic three-dimensional printing program 122, computing environment 300 includes, for example, computer 301, wide area network (WAN) 302, end user device (EUD) 303, remote server 304, public cloud 305, and private cloud 306. In this embodiment, computer 301 includes processor set 310 (including processing circuitry 320 and cache 321), communication fabric 311, volatile memory 312, persistent storage 313 (including operating system 322 and automatic three-dimensional printing program 122, as identified above), peripheral device set 314 (including user interface (UI), device set 323, storage 324, and Internet of Things (IoT) sensor set 325), and network module 315. Remote server 304 includes remote database 330. Public cloud 305 includes gateway 340, cloud orchestration module 341, host physical machine set 342, virtual machine set 343, and container set 344.

Computer 301, which represents server 120 of FIG. 1, may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 330. As is well understood in the art of computer technology, and depending upon the technology, performance of a computer-implemented method may be distributed among multiple computers and/or between multiple locations. On the other hand, in this presentation of computing environment 300, detailed discussion is focused on a single computer, specifically computer 301, to keep the presentation as simple as possible. Computer 301 may be located in a cloud, even though it is not shown in a cloud in FIG. 3. On the other hand, computer 301 is not required to be in a cloud except to any extent as may be affirmatively indicated.

Processor set 310 includes one, or more, computer processors of any type now known or to be developed in the future. Processing circuitry 320 may be distributed over multiple packages, for example, multiple, coordinated integrated circuit chips. Processing circuitry 320 may implement multiple processor threads and/or multiple processor cores. Cache 321 is memory that is located in the processor chip package(s) and is typically used for data or code that should be available for rapid access by the threads or cores running on processor set 310. Cache memories are typically organized into multiple levels depending upon relative proximity to the processing circuitry. Alternatively, some, or all, of the cache for the processor set may be located “off chip.” In some computing environments, processor set 310 may be designed for working with qubits and performing quantum computing.

Computer readable program instructions are typically loaded onto computer 301 to cause a series of operational steps to be performed by processor set 310 of computer 301 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 321 and the other storage media discussed below. The program instructions, and associated data, are accessed by processor set 310 to control and direct performance of the inventive methods. In computing environment 300, at least some of the instructions for performing the inventive methods may be stored in automatic three-dimensional printing program 122 in persistent storage 313.

Communication fabric 311 is the signal conduction paths that allow the various components of computer 301 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 312 is any type of volatile memory now known or to be developed in the future. Examples include dynamic type random access memory (RAM) or static type RAM. Typically, the volatile memory is characterized by random access, but this is not required unless affirmatively indicated. In computer 301, the volatile memory 312 is located in a single package and is internal to computer 301, but, alternatively or additionally, the volatile memory may be distributed over multiple packages and/or located externally with respect to computer 301.

Persistent storage 313 is any form of non-volatile storage for computers that is now known or to be developed in the future. The non-volatility of this storage means that the stored data is maintained regardless of whether power is being supplied to computer 301 and/or directly to persistent storage 313. Persistent storage 313 may be a read only memory (ROM), but typically at least a portion of the persistent storage allows writing of data, deletion of data and re-writing of data. Some familiar forms of persistent storage include magnetic disks and solid-state storage devices. Operating system 322 may take several forms, such as various known proprietary operating systems or open-source Portable Operating System Interface type operating systems that employ a kernel. The code included in automatic three-dimensional printing program 122 typically includes at least some of the computer code involved in performing the inventive methods.

Peripheral device set 314 includes the set of peripheral devices of computer 301. Data communication connections between the peripheral devices and the other components of computer 301 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 323 may include components such as a display screen, speaker, microphone, wearable devices (such as goggles and smart watches), keyboard, mouse, printer, touchpad, game controllers, and haptic devices. Storage 324 is external storage, such as an external hard drive, or insertable storage, such as an SD card. Storage 324 may be persistent and/or volatile. In some embodiments, storage 324 may take the form of a quantum computing storage device for storing data in the form of qubits. In embodiments where computer 301 is required to have a large amount of storage (for example, where computer 301 locally stores and manages a large database) then this storage may be provided by peripheral storage devices designed for storing very large amounts of data, such as a storage area network (SAN) that is shared by multiple, geographically distributed computers. IoT sensor set 325 is made up of sensors that can be used in Internet of Things applications. For example, one sensor may be a thermometer and another sensor may be a motion detector.

Network module 315 is the collection of computer software, hardware, and firmware that allows computer 301 to communicate with other computers through WAN 302. Network module 315 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 315 are performed on the same physical hardware device. In other embodiments (for example, embodiments that utilize software-defined networking (SDN)), the control functions and the forwarding functions of network module 315 are performed on physically separate devices, such that the control functions manage several different network hardware devices. Computer readable program instructions for performing the inventive methods can typically be downloaded to computer 301 from an external computer or external storage device through a network adapter card or network interface included in network module 315.

WAN 302 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 303 is any computer system that is used and controlled by an end user (for example, a customer of an enterprise that operates computer 301) and may take any of the forms discussed above in connection with computer 301. EUD 303 typically receives helpful and useful data from the operations of computer 301. For example, in a hypothetical case where computer 301 is designed to provide a recommendation to an end user, this recommendation would typically be communicated from network module 315 of computer 301 through WAN 302 to EUD 303. In this way, EUD 303 can display, or otherwise present, the recommendation to an end user. In some embodiments, EUD 303 may be a client device, such as thin client, heavy client, mainframe computer, desktop computer and so on.

Remote server 304 is any computer system that serves at least some data and/or functionality to computer 301. Remote server 304 may be controlled and used by the same entity that operates computer 301. Remote server 304 represents the machine(s) that collect and store helpful and useful data for use by other computers, such as computer 301. For example, in a hypothetical case where computer 301 is designed and programmed to provide a recommendation based on historical data, then this historical data may be provided to computer 301 from remote database 330 of remote server 304.

Public cloud 305 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economics of scale. The direct and active management of the computing resources of public cloud 305 is performed by the computer hardware and/or software of cloud orchestration module 341. The computing resources provided by public cloud 305 are typically implemented by virtual computing environments that run on various computers making up the computers of host physical machine set 342, which is the universe of physical computers in and/or available to public cloud 305. The virtual computing environments (VCEs) typically take the form of virtual machines from virtual machine set 343 and/or containers from container set 344. It is understood that these VCEs may be stored as images and may be transferred among and between the various physical machine hosts, either as images or after instantiation of the VCE. Cloud orchestration module 341 manages the transfer and storage of images, deploys new instantiations of VCEs and manages active instantiations of VCE deployments. Gateway 340 is the collection of computer software, hardware, and firmware that allows public cloud 305 to communicate through WAN 302.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 306 is similar to public cloud 305, except that the computing resources are only available for use by a single enterprise. While private cloud 306 is depicted as being in communication with WAN 302, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 305 and private cloud 306 are both part of a larger hybrid cloud.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The foregoing descriptions of the various embodiments of the present invention have been presented for purposes of illustration and example but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method comprising:
responsive to determining that a user has purchased a new product that the user intends to use to replace or repair a currently owned product with based on a purchase history of the user, identifying, by one or more processors, one or more components of the currently owned product to be repaired or replaced with the new product;
retrieving, by the one or more processors, a 3D printing file associated with the one or more components; and
automatically 3D printing, by the one or more processors, the one or more components using the 3D printing file.

2. The computer-implemented method of claim 1, further comprising:
prior to determining that the user has purchased the new product that the user intends to use to replace or repair the currently owned product with based on the purchase history of the user, gathering, by the one or more processors, a prior purchase history of the user on an e-commerce platform;
capturing, by the one or more processors, a search history and a previously viewed history of the user on the e-commerce platform; and
extracting, by the one or more processors, a word, a topic, or a family of products associated with the word or the topic from the search history and the previously viewed history of the user on the e-commerce platform.

3. The computer-implemented method of claim 2, further comprising:
subsequent to extracting the word, the topic, or the family of products associated with the word or the topic extracted from the search history and the previously viewed history of the user on the e-commerce platform, querying, by the one or more processors, a mapping table to view the currently owned product to be repaired or replaced with the new product, wherein the mapping table is comprised of a first side associated with one or more product tags and one or more known associations and a second side associated with a reference to the 3D printing file.

4. The computer-implemented method of claim 1, wherein the one or more components of the currently owned product to be repaired or replaced with the new product are identified based on a first indication of a malfunctioning component of the currently owned product or based on a second indication of a need for improvement to the currently owned product.

5. The computer-implemented method of claim 1, wherein the 3D printing file is specific to the currently owned product to be repaired or replaced with the new product.

6. The computer-implemented method of claim 1, wherein the one or more components 3D printed meet one or more usability parameters, and wherein the one or more usability parameters are one or more of an expected lifetime, one or more operating characteristics, and one or more cost constraints.

7. The computer-implemented method of claim 1, further comprising:
compensating, by the one or more processors, the user for preparing a three-dimensional print of the currently owned product to be repaired or replaced with the new product.

8. The computer-implemented method of claim 1, further comprising:
subsequent to automatically 3D printing the one or more components using the 3D printing file, outputting, by the one or more processors, a request for feedback to the user;
receiving, by the one or more processors, a set of feedback input by the user;
processing, by the one or more processors, the set of feedback input by the user; and
incorporating, by the one or more processors, the set of feedback into how a component of the currently owned product to repaired or replaced with the new product is identified.

9. A computer program product comprising:
one or more computer readable storage media and program instructions stored on the one or more computer readable storage media, the program instructions comprising:
responsive to determining that a user has purchased a new product that the user intends to use to replace or repair a currently owned product with based on a purchase history of the user, program instructions to identify one or more components of the currently owned product to be repaired or replaced with the new product;
program instructions to retrieve a 3D printing file associated with the one or more components; and
program instructions to automatically 3D print the one or more components using the 3D printing file.

10. The computer program product of claim 9, further comprising:
prior to determining that the user has purchased the new product that the user intends to use to replace or repair the currently owned product with based on the purchase history of the user, program instructions to gather a prior purchase history of the user on an e-commerce platform;
program instructions to capture a search history and a previously viewed history of the user on the e-commerce platform; and
program instructions to extract a word, a topic, or a family of products associated with the word or the topic from the search history and the previously viewed history of the user on the e-commerce platform.

11. The computer program product of claim 10, further comprising:
subsequent to extracting the word, the topic, or the family of products associated with the word or the topic extracted from the search history and the previously viewed history of the user on the e-commerce platform, program instructions to query a mapping table to view the currently owned product to be repaired or replaced with the new product, wherein the mapping table is comprised of a first side associated with one or more product tags and one or more known associations and a second side associated with a reference to the 3D printing file.

12. The computer program product of claim 9, wherein the one or more components of the currently owned product to be repaired or replaced with the new product are identified based on a first indication of a malfunctioning component of the currently owned product or based on a second indication of a need for improvement to the currently owned product.

13. The computer program product of claim 9, wherein the 3D printing file is specific to the currently owned product to be repaired or replaced with the new product.

14. The computer program product of claim 9, further comprising:
subsequent to automatically 3D printing the one or more components using the 3D printing file, program instructions to output a request for feedback to the user;
program instructions to receive a set of feedback input by the user;
program instructions to process the set of feedback input by the user; and
program instructions to incorporate the set of feedback into how a component of the currently owned product to repaired or replaced with the new product is identified.

15. A computer system comprising:
one or more computer processors;
one or more computer readable storage media;
program instructions collectively stored on the one or more computer readable storage media for execution by at least one of the one or more computer processors, the stored program instructions comprising:
responsive to determining that a user has purchased a new product that the user intends to use to replace or repair a currently owned product with based on a purchase history of the user, program instructions to identify one or more components of the currently owned product to be repaired or replaced with the new product;
program instructions to retrieve a 3D printing file associated with the one or more components; and
program instructions to automatically 3D print the one or more components using the 3D printing file.

16. The computer system of claim 15, further comprising:
prior to determining that the user has purchased the new product that the user intends to use to replace or repair the currently owned product with based on the purchase history of the user, program instructions to gather a prior purchase history of the user on an e-commerce platform;
program instructions to capture a search history and a previously viewed history of the user on the e-commerce platform; and
program instructions to extract a word, a topic, or a family of products associated with the word or the topic from the search history and the previously viewed history of the user on the e-commerce platform.

17. The computer system of claim 16, further comprising:
subsequent to extracting the word, the topic, or the family of products associated with the word or the topic extracted from the search history and the previously viewed history of the user on the e-commerce platform, program instructions to query a mapping table to view the currently owned product to be repaired or replaced with the new product, wherein the mapping table is comprised of a first side associated with one or more product tags and one or more known associations and a second side associated with a reference to the 3D printing file.

18. The computer system of claim 15, wherein the one or more components of the currently owned product to be repaired or replaced with the new product are identified based on a first indication of a malfunctioning component of the currently owned product or based on a second indication of a need for improvement to the currently owned product.

19. The computer system of claim 15, wherein the 3D printing file is specific to the currently owned product to be repaired or replaced with the new product.

20. The computer system of claim 15, further comprising:
subsequent to automatically 3D printing the one or more components using the 3D printing file, program instructions to output a request for feedback to the user;
program instructions to receive a set of feedback input by the user;
program instructions to process the set of feedback input by the user; and
program instructions to incorporate the set of feedback into how a component of the currently owned product to repaired or replaced with the new product is identified.
